(19) United States
(12) Patent Application Publication
(10) Pub. No.: US 2017/0318797 A1
(43) Pub. Date: Nov. 9, 2017

(54) Device for Repelling Animals

(71) Applicant: Ed Smith, Allardt, TN (US)

(72) Inventor: Ed Smith, Allardt, TN (US)

(21) Appl. No.: 15/145,844

(22) Filed: May 4, 2016

(51) Int. Cl. A01M 29/12; A01M 29/16

(52) U.S. Cl. CPC A01M 29/12; A01M 29/16

(57) ABSTRACT

A predator simulation apparatus for repelling animals may include a housing. A speaker may be disposed on the housing. The speaker may also be configured to emit an animal repellant sound. A scent dispenser may be disposed on the housing. The scent dispenser may be configured to release an animal repellant odor. A motion sensor may be electrically coupled to the speaker. A control switch may also be electrically coupled to the speaker.

A portion of the disclosure of this patent document contains material that is subject to copyright protection. The copyright owner has no objection to the reproduction of the patent document or the patent disclosure as it appears in the U.S. Patent and Trademark Office patent file or records, but otherwise reserves all copyright rights whatsoever.

### BACKGROUND

The present disclosure relates generally to devices for dispensing scent and emitting sound. More particularly, this disclosure pertains to repelling unwanted animals.

Visual animal repelling devices such as scarecrows or artificial owls are known. These devices generally only repel birds from an area. Rabbits, deer, moles, mice, and other mammals may not be repelled by such a device. The birds must also see the device for it to potentially repel the birds. Birds may also become used to the device, and it may become ineffective.

What is needed, then, is a device that may repel animals through the use of sound and scent.

### BRIEF SUMMARY

The present disclosure is directed, in a first non-limiting embodiment, to a predator simulation apparatus for repelling animals. The predator simulation apparatus may include a housing. A speaker may be disposed on the housing. The speaker may also be configured to emit an animal repellant sound. A scent dispenser may be disposed on the housing. The scent dispenser may be configured to release an animal repellant odor. A motion sensor may be electrically coupled to the speaker. A control switch may also be electrically coupled to the speaker.

Another embodiment may include a timer electrically coupled to the speaker.

A further embodiment may include the control switch configured to allow a user to select from an off mode, a motion activated mode, and a timed mode.

A still further embodiment may include the motion sensor, the control switch, and the timer also electrically coupled to the scent dispenser.

Yet another embodiment may include the animal repellant sound including a recording of a predator of the animals to be repelled.

Still another embodiment may include the predator including a coyote.

A non-limiting embodiment may include the animal repellant odor including a liquid scent of a predator of the animals to be repelled.

Another embodiment may include the liquid scent including urine of the predator.

An embodiment may include the urine including coyote urine.

At least one embodiment may include the animal repellant sound and the animal repellant odor configured to not repel insects.

The present disclosure is also directed, in a non-limiting embodiment, to a method of repelling animals. The method may comprise emitting an animal repellant sound at a time interval in a timed mode; emitting the animal repellant sound upon detecting motion with a motion sensor in a motion activated mode; and releasing an animal repellant odor.

Another embodiment may further include releasing the animal repellant odor at a time interval in the timed mode; and releasing the animal repellant odor upon detecting motion with the motion sensor in the motion activated mode.

Still another embodiment may include emitting the animal repellant sound a plurality of times, subsequent times separated by the time interval.

Yet another embodiment may include emitting the animal repellant sound at both the time interval and upon detecting motion in a mixed mode.

A further embodiment may include the step of emitting an animal repellant sound at a time interval in a timed mode and the step of emitting the animal repellant sound upon detecting motion with a motion sensor in a motion activated mode both including emitting a recording of a predator of the animals to be repelled.

A still further embodiment may include the predator being a coyote.

Another embodiment may include the step of releasing an animal repellant odor including releasing a liquid scent of a predator of the animals to be repelled.

Some embodiments may include the liquid scent including urine of the predator.

At least one embodiment may include the urine being coyote urine.

A further embodiment may include allowing insects to remain unrepelled.

### BRIEF DESCRIPTION OF THE SEVERAL VIEWS OF THE DRAWINGS

FIG. 1 is a perspective view of an embodiment of a device for repelling animals connected to a corresponding mounting bracket.

FIG. 2 is a perspective view of the device of FIG. 1 exploded from the mounting bracket.

FIG. 3 is front elevation view of the device of FIG. 1.

FIG. 4 is a back elevation view of the device of FIG. 1.

FIG. 5 is a top plan view of the device of FIG. 1.

FIG. 6 is a bottom plan view of the device of FIG. 1.

### DETAILED DESCRIPTION

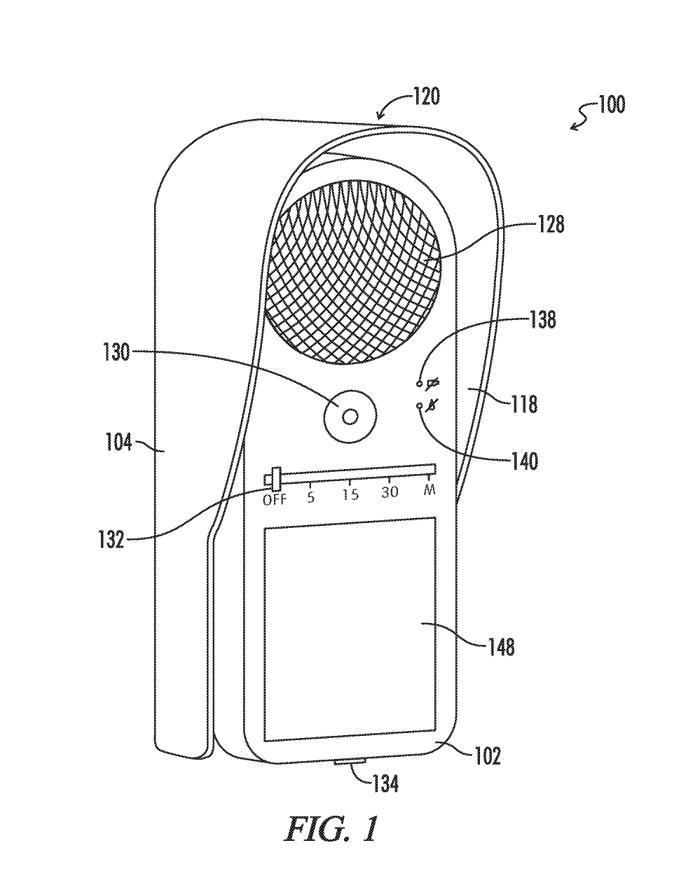

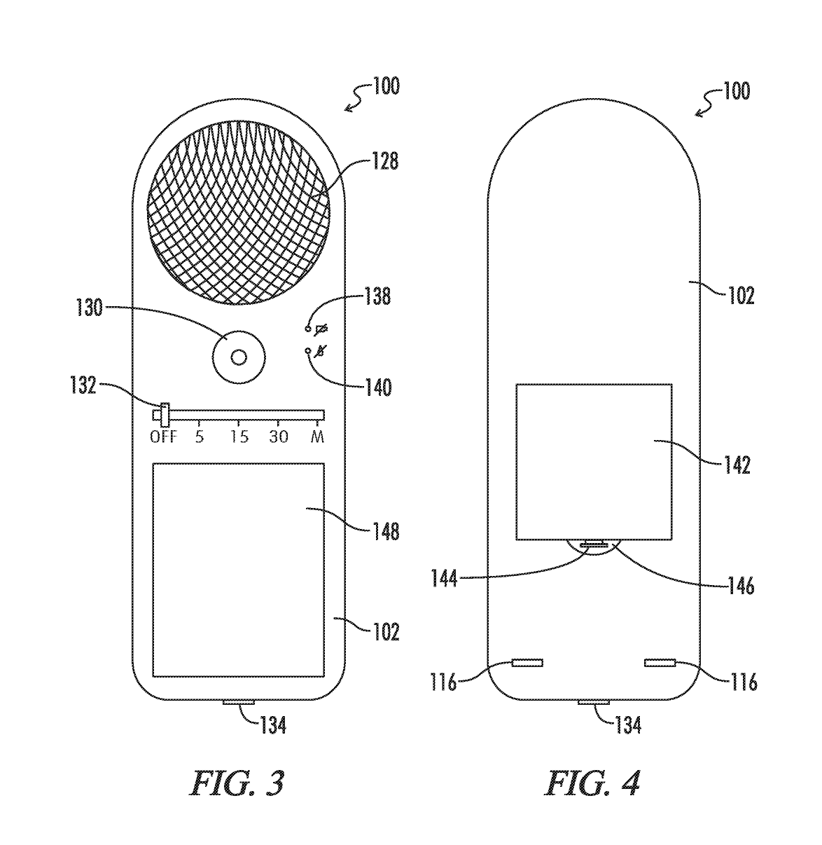

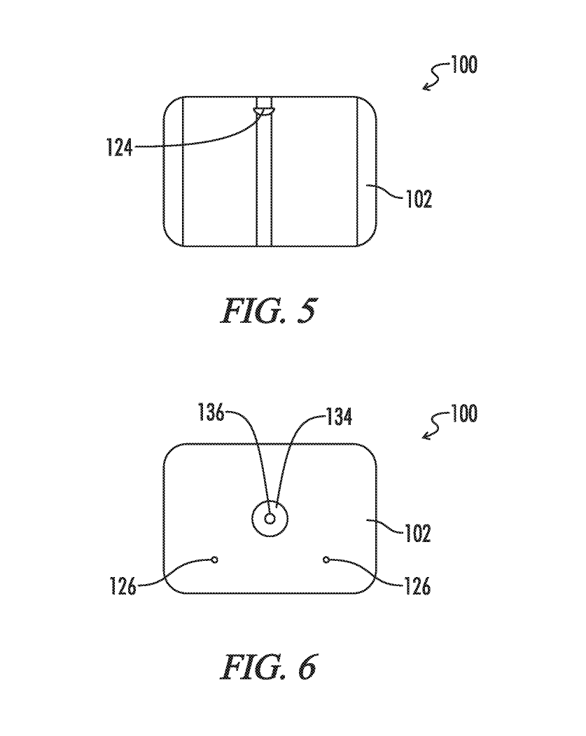

Referring now to FIGS. 1-6, a predator simulation apparatus 100 is shown. The predator simulation apparatus 100 may include a housing 102. The predator simulation apparatus 100 may also include a mounting bracket 104. The mounting bracket 104 may include a plurality of through bores 106 configured to allow corresponding screws 108 to pass through the mounting bracket to engage a mounting surface (not shown). The housing 102 may be received on the mounting bracket 104. The mounting bracket 104 may include mounting posts 110. Each mounting post 110 may include a threaded hole 112 to receive a corresponding bolt 114. The mounting posts 110 may be received in corresponding receiving slots 116 formed in the housing 102. The mounting bracket 104 may also include a side wall 118 disposed along at least a portion of its periphery. The side wall 118 may aid in receiving the housing 102 in the mounting bracket 104. The side wall 118 may also form a rain hood 120 configured to prevent at least some rain from falling on the housing 102 when the predator simulation apparatus 100 is mounted outdoors. The side wall 118 may include a resilient member 122 projecting therefrom. The resilient member 122 may be integrally formed with the mounting bracket 104 or may be attached to the mounting bracket in any other appropriate manner. The resilient member 122 may be configured to be received in a recess 124 located in the top of the housing 102. Alternative embodiments may include a plurality of resilient members 122 and corresponding recesses 124 located in any appropriate locations so as to maintain the housing 102 on the mounting bracket 104.

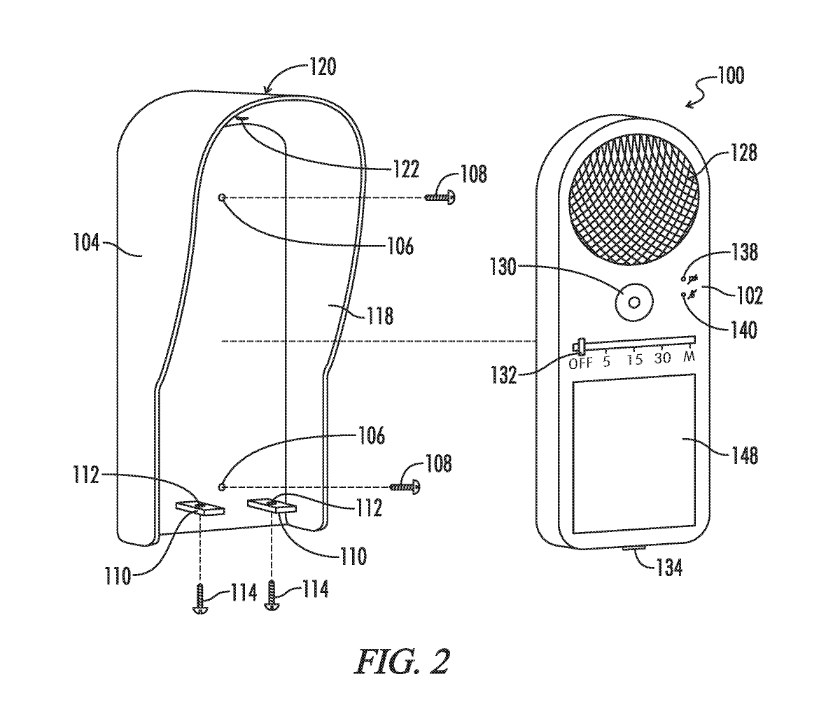

In the embodiment shown in FIGS. 1 and 2, the housing 102 may be slid onto the mounting bracket 104 such that the mounting posts 110 are received in the receiving slots 116. Next, the upper portion of the housing 102 may be pressed toward the mounting bracket 104 such that the resilient member 122 deflects. Once the resilient member 122 enters the recess 124, the resilient member may return to its normal orientation. The bolts 114 may then be inserted into the housing 102 through unthreaded holes 126 in the bottom of the housing to thread into the threaded holes 112 of the mounting posts 110 inside the housing.

In some embodiments, to remove the housing 102 from the mounting bracket 104, the bolts 114 must first be removed. Next, the housing 102 may be pulled at its bottom portion such that the top portion pivots slightly. As the mounting posts 110 are removed from the receiving slots 116, the recess 124 may move such that the resilient member 122 may be removed therefrom. Then, the housing 102 may be pulled away from the mounting bracket 104. In alternative embodiments, the housing 102 may simply be pulled directly away from the mounting bracket 104 with no pivoting motion. In such embodiments, the resilient member 122 may deflect out of the recess 124 upon experiencing a threshold force.

The predator simulation apparatus 100 may also include a speaker 128 disposed on the housing 102. In some embodiments, the speaker 128 may be mounted on the housing 102 or within the housing. The speaker 128 may be of any appropriate construction and may be configured to emit an animal repellant sound. In some embodiments, the speaker 128 may emit a recording of a predator of the animals to be repelled by the predator simulation apparatus 100. The recording may be one or more calls, growls, howls, yips, or other natural sounds a given predator may make. Other embodiments may include the speaker 128 emitting a simulated predator sound. In some embodiments, the predator simulation apparatus 100 may play only a single predator sound or recording. In other embodiments, the speaker 128 may emit a variety of predator sounds or recordings in a pattern or in a randomized manner. In a non-limiting example, the speaker 128 may first emit a howl and later emit a growl of a given predator. An appropriate predator may include any animal the unwanted animals would avoid. Such predators may include wolves, coyotes, dogs, or any other carnivorous or omnivorous animal. Other embodiments of the predator simulation apparatus 100 may instead emit ultrasonic or subsonic sounds or other sounds that undesired animals may find irritating. The various sounds may be played immediately after each other or separated from each other by a given time interval.

In one non-limiting embodiment of the predator simulation apparatus 100, the predator sounds may be changed, deleted, or added to such that the pattern or randomized sequence of sounds may be updated. Additional predator sounds or other sounds may be downloaded to the predator simulation apparatus 100 through any appropriate means including, but not limited to, through a USB or other connection port, wirelessly over Bluetooth or Wi-Fi, or both. The additional sounds to be downloaded may be acquired from a coupled personal computer, smartphone, and the like or may be downloaded directly to the predator simulation apparatus 100 from a wireless network or an internet website.

Some embodiments of the predator simulation apparatus 100 may include a mechanical or electronic timer (not shown) electrically coupled to the speaker 128. In a particular non-limiting embodiment, a controller may be disposed within the housing 102. The controller may be configured to operate timer software in addition to its other functions. In such an embodiment, the timer may be said to be within the controller. The controller may be electrically coupled to the speaker 128.

A motion sensor 130 may be electrically coupled to the speaker 128. In some embodiments, the motion sensor 130 may be electrically coupled to both the speaker 128 and the controller. The motion sensor 130 may be configured to detect motion in a vicinity of the predator simulation apparatus 100. The motion sensor 130 may be any appropriate sensor that may detect an animal to be repelled. Non-limiting examples of an appropriate motion sensor 130 may include passive infrared sensors, microwave sensors, area reflective type sensors, ultrasonic sensors, vibration sensors, video motion sensors, contact motion sensors, and any combination thereof. The speaker 128 may be configured to emit a predator sound upon receiving a signal from the motion sensor 130 corresponding with detected motion. In some embodiments, the rain hood 120 and side wall 118 may be configured to restrict a portion of the viewing area of the motion sensor 130 so as to limit the functionality of the motion sensor to areas the user desires. Such a configuration may, for instance, allow the motion sensor 130 to detect small ground mammals, but not birds flying overhead.

A control switch 132 may also be electrically coupled to the speaker 128. In some embodiments, the control switch 132 may be electrically coupled to the motion sensor 130 as well as the speaker 128. In other embodiments, the control switch 132 may also be electrically coupled to the controller including the timer. The control switch 132 may be of any appropriate construction to allow a user to set the operation mode of the predator simulation apparatus 100. The control switch 132 may, for instance, be a touch screen, a slide switch, tab switches, a dial, push buttons, or any combination thereof. In a non-limiting example, the control switch 132 may include selection positions to allow a user to choose from an off mode, a timed mode, and a motion activated mode. Other embodiments may include a mixed mode that includes both the timed mode and the motion activated mode functions. In such a mode, the speaker 128 may activate upon the passing of a given time interval as well as upon the motion sensor detecting motion. Some embodiments may include multiple timed mode selections including, but not limited to, activating the speaker 128 every 5 minutes, 15 minutes, 30 minutes, and the like. Still another embodiment may include a continuous activation mode that activates the speaker 128 to emit sounds on a loop until the control switch 132 is set to another mode. The housing 102 may also include a volume control (not shown) which may be part of the control switch 132.

A scent dispenser 134 may also be disposed on or in the housing 102. The scent dispenser 134 may be configured to release an animal repellant odor. The scent dispenser 134 may be of any appropriate construction to release an animal repellant odor including, but not limited to, a drop releasing container, a heating element receiving a scent liquid to be evaporated, a sponge or other absorbent material soaked in the animal repellant odor liquid, any combination thereof, and the like. A particular possible embodiment may include a drain hole 136 disposed at the bottom of the housing 102 such that a drop of liquid scent falls from the housing at a given interval. The scent dispenser 134 may be configured to release scent mechanically through gravity at a given interval by sizing the drain hole 136 appropriately. In other embodiments, the scent dispenser 134 may release liquid scent upon opening one or more gates or valves (not shown) that prevent dispensation of the liquid scent when in the closed position. In still another embodiment, the scent dispenser 134 may include a container (not shown) holding the liquid scent with the drain hole 136 configured to hold the liquid scent in the container until a compressive force is placed on the container. Regardless of the mode of scent dispensation, the scent dispenser 134 may also be electrically coupled to one or more of the motion sensor, the control switch, the timer, and the controller. As such, the scent dispenser 134 may also release scent according to the timed mode, motion activated mode, mixed mode, or continuous activation mode.

In some embodiments, the repellant odor includes a liquid scent of a predator of the animals to be repelled. Such predators may include wolves, coyotes, dogs, and the like. One embodiment may include the liquid scent including urine of the predator. A non-limiting example may include coyote urine. Some embodiments may include the scent dispenser 134 including multiple scent compartments to allow for the dispenser to dispense different scent liquids depending on a user's selection. A user may select a given predator, and the corresponding sounds and scent will be emitted from the predator simulation apparatus 100. A user may also select a pattern or randomized mode that allows a different one of a plurality of predators to be simulated at a given time interval.

The animals to be repelled by the predator simulation apparatus 100 may include, in non-limiting examples, deer, rabbits, squirrels, chipmunks, groundhogs, mice, moles, shrews, opossums, and the like. At least one embodiment of the predator simulation apparatus 100 may repel animals such as those listed while allowing insects to continue to inhabit the area. Certain areas, such as gardens or crop fields, may benefit from allowing insects access to the plants or soil around the plants while preventing animals such as those listed from consuming or damaging the plants.

The predator simulation apparatus 100 may also include other features, such as a low battery indicator light 138 disposed on the housing 102. Similarly, a low liquid scent level indicator light 140 may be disposed on the housing 102. A user may then simply inspect the front of the housing 102 to determine if new batteries or more liquid scent is needed. One non-limiting embodiment may include a transparent portion of the housing 102 configured to allow a user to see the liquid scent level in the scent container.

The housing 102 may further include an access panel 142 to allow the user to access internal components such as the batteries and the scent container. In a non-limiting example, the access panel 142 may include a resilient latch 144 that may engage a corresponding portion of the housing 102. A latch recess 146 may be formed in the housing 102 to allow a user access to the resilient latch 144. Although batteries have been mentioned, it is understood that the predator simulation apparatus 100 may additionally or alternatively include a cord to receive electricity from an outside source. One non-limiting example of the predator simulation apparatus 100 may include at least one solar panel (not shown) disposed on either the housing 102 or the mounting bracket 104. The solar panel may provide all or a part of the electrical energy required to power the predator simulation apparatus 100.

The predator simulation apparatus 100 may further include a display panel 148 configured to display any appropriate surface indicia. In one non-limiting embodiment, the display panel 148 may be a display screen that shows the animal the predator simulation apparatus 100 is set to simulate. In an alternative embodiment, the display panel may show the animal the predator simulation apparatus 100 is set to repel. Some embodiments may simply include the display panel 148 configured to receive desired labelling for marketing purposes.

The components of the predator simulation apparatus 100 may be made of any appropriate materials and be of any appropriate construction. The housing 102 and mounting bracket 104 may be made of, for example, any appropriate polymers, metals, composites, and the like.

Thus, although there have been described particular embodiments of the present invention of a new and useful “device for repelling animals”, it is not intended that such references be construed as limitations upon the scope of this invention except as set forth in the following claims.

What is claimed is:

1. A predator simulation apparatus for repelling animals, the apparatus comprising:
a housing;
a speaker disposed on the housing, the speaker configured to emit an animal repellant sound;
a scent dispenser disposed on the housing, the scent dispenser configured to release an animal repellant odor;
a motion sensor electrically coupled to the speaker; and
a control switch electrically coupled to the speaker.

2. The predator simulation apparatus of claim 1, further comprising:
a timer electrically coupled to the speaker.

3. The predator simulation apparatus of claim 2, wherein the control switch is configured to allow a user to select from an off mode, a motion activated mode, and a timed mode.

4. The predator simulation apparatus of claim 2, wherein the motion sensor, the control switch, and the timer are also electrically coupled to the scent dispenser.

5. The predator simulation apparatus of claim 1, wherein the animal repellant sound includes a recording of a predator of the animals to be repelled.

6. The predator simulation apparatus of claim 5, wherein the predator includes a coyote.

7. The predator simulation apparatus of claim 1, wherein the animal repellant odor includes a liquid scent of a predator of the animals to be repelled.

8. The predator simulation apparatus of claim 7, wherein the liquid scent includes urine of the predator.

9. The predator simulation apparatus of claim 8, wherein the urine includes coyote urine.

10. The predator simulation apparatus of claim 1, wherein the animal repellant sound and the animal repellant odor are configured to not repel insects.

11. A method of repelling animals, the method comprising:
(a) emitting an animal repellant sound at a time interval in a timed mode;
(b) emitting the animal repellant sound upon detecting motion with a motion sensor in a motion activated mode; and
(c) releasing an animal repellant odor.

12. The method of claim 11, wherein step (c) further comprises:
releasing the animal repellant odor at a time interval in the timed mode; and
releasing the animal repellant odor upon detecting motion with the motion sensor in the motion activated mode.

13. The method of claim 11, wherein step (a) further includes emitting the animal repellant sound a plurality of times, subsequent times separated by the time interval.

14. The method of claim 11, further comprising:
emitting the animal repellant sound at both the time interval and upon detecting motion in a mixed mode.

15. The method of claim 11, wherein steps (a) and (b) include emitting a recording of a predator of the animals to be repelled.

16. The method of claim 15, wherein the predator is a coyote.

17. The method of claim 11, wherein step (c) includes releasing a liquid scent of a predator of the animals to be repelled.

18. The method of claim 17, wherein the liquid scent includes urine of the predator.

19. The method of claim 18, wherein the urine is coyote urine.

20. The method of claim 11, further comprising:
allowing insects to remain unrepelled.
